(19) United States
(12) Patent Application Publication
(10) Pub. No.: US 2025/0023139 A1
(43) Pub. Date: Jan. 16, 2025

(54) BATTERY MODULE

(71) Applicant: Robert Bosch GmbH, Stuttgart (DE)

(72) Inventor: Markus Schmitt, Tamm (DE)

(21) Appl. No.: 18/753,333

(22) Filed: Jun. 25, 2024

(30) Foreign Application Priority Data
Jul. 11, 2023 (DE) 10 2023 206 589.4

(51) Int. Cl. H01M 10/6552; H01M 10/0525; H01M 10/42; H01M 10/613; H01M 10/647; H01M 10/658; H01M 50/209; H01M 50/227; H01M 50/507

(52) U.S. Cl. CPC H01M 10/6552; H01M 10/0525; H01M 10/4257; H01M 10/613; H01M 10/647; H01M 10/658; H01M 50/209; H01M 50/227; H01M 50/507

(57) ABSTRACT

A battery module includes a plurality of battery cells and has an electrical switching device. A first connection of the electrical switching device is electrically conductively connected to a battery cell of the plurality of battery cells by a first first busbar, which is electrically conductively connected to the battery cell, and a second connection of the electrical switching device is electrically conductively connected to an overall voltage tap of the battery module by a first second busbar, which is electrically conductively connected to the overall voltage tap. A first heat pipe is thermally conductively connected to the first first busbar and/or a second heat pipe is thermally conductively connected to the first second busbar. The first heat pipe and/or the second heat pipe are thermally conductively connected to a temperature control body.

### BACKGROUND

The invention is based on a battery module.

A battery module usually has a plurality of individual battery cells, each of which has a positive voltage tap and a negative voltage tap, wherein the respective voltage taps are electrically conductively connected to each other for an electrically conductive serial and/or parallel connection of the plurality of battery cells to each other and can thus be interconnected to form the battery module. In particular, the battery cells can each have a first voltage tap, in particular a positive voltage tap, and a second voltage tap, in particular a negative voltage tap, which are electrically conductively connected to each other by means of cell connectors, so that an electrically serial and/or parallel connection is formed. Battery modules are themselves in turn interconnected into batteries or entire battery systems.

Electrical switching devices such as a relay, for example, are usually arranged between a voltage tap of a terminal battery cell of a battery module and the overall voltage tap of such a battery module and are used to switch the battery module or the battery, which comprises such a battery module, on and off.

In principle, such electrical switching devices must be actively cooled, especially as they carry the entire current of the battery module. For this purpose, the electrical switching device can be connected to a heat sink, such as a metal housing of the battery module.

Prior art in this regard includes, for example, DE 10 2022 203 908, DE 10 2022 203 860 and DE 10 2022 203 861, which describe cooling of an electrical switching device by means of liquid cooling or air cooling, wherein the heat sink is an integral part of a housing structure of the housing of the battery module.

In order to provide good heat dissipation of the electrical switching device, the housing of the battery module is preferably made of a metal with comparably good thermal conductivity-preferably as a die-cast aluminum component.

### SUMMARY

A battery module according to the disclosure offers the advantage that reliable temperature control, in particular cooling, of an electrical switching device of the battery module can be provided. In particular, such temperature control can be provided indirectly or by an intermediary via busbars by means of at least one heat pipe.

In accordance with the invention, a battery module with a plurality of battery cells, which are designed in particular as lithium-ion battery cells, is provided for this purpose.

The battery module also comprises an electrical switching device, in particular a relay.

A first first busbar is electrically conductively connected to a battery cell of the plurality of battery cells. Furthermore, the first connection of the electrical switching device is electrically conductively connected to the battery cell by means of the first first busbar. In particular, this therefore forms an electrical contact between the battery cell and the first connection.

A first second busbar is electrically conductively connected to an overall voltage tap of the battery module. Furthermore, the second connection of the electrical switching device is connected to the overall voltage tap of the battery module by means of the first second busbar. In particular, this therefore forms an electrical contact between the overall voltage tap and the second connection.

Furthermore, a first heat pipe is thermally conductively connected to the first first busbar and/or a second heat pipe is thermally conductively connected to the first second busbar.

In addition, the first heat pipe and/or the second heat pipe are thermally conductively connected to a temperature control body.

Advantageous further developments and improvements of the device specified in the independent claim are possible by means of the measures listed in the dependent claims.

In particular, the first first busbar is mechanically connected to the battery cell, in particular to a voltage tap of the battery cell, for example by means of a material bond, in particular by means of a welded connection.

In particular, the first second busbar is mechanically connected to the overall voltage tap, for example by means of a material bond, in particular by means of a welded connection.

Furthermore, the electrically conductive connections between the first connection and the battery cell by means of the first first busbar and between the second connection and the overall voltage tap by means of the first second busbar can each be formed directly or indirectly. As will be described below, in the case of a direct connection, the first first busbar can continue to be connected to the first connection mechanically, e.g. by means of a material bond, in particular by means of a welded connection, or the first second busbar can continue to be connected to the second connection mechanically, e.g. by means of a material bond, in particular by means of a welded connection. As will be described below, in the case of an indirect connection between the first first busbar and the first connection, a second first busbar can be arranged or a second second busbar can be arranged between the first second busbar and the second connection.

It should be noted that a heat pipe is a heat exchanger, also known as a heat pipe, which allows a high heat flow density by using the enthalpy of vaporization of a medium. This means that comparably large amounts of heat can be transferred over a small cross-sectional area. When heat is transferred to the heat pipe, liquid evaporates within the heat pipe, wherein the absorbed heat is transferred through the heat pipe to the temperature control body with a comparably small temperature difference. The heat can be released from the temperature control body by means of free or forced convection.

At this point, it should be noted that the plurality of battery cells are each designed in particular as prismatic battery cells. Prismatic battery cells each comprise a battery cell housing with a total of six lateral surfaces, which are arranged in pairs opposite each other and substantially parallel to each other. Furthermore, lateral surfaces arranged adjacent to one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface.

It should also be noted at this point that a fuse can also be arranged between the second connection and the overall voltage tap. In particular, the fuse can be arranged within the first second busbar or the second second busbar.

Furthermore, the plurality of battery cells is arranged adjacent to one another, in particular in a longitudinal direction of the battery module. In an adjacent arrangement of the battery cells in a longitudinal direction of the battery module, the battery cells are arranged adjacent to one another by way of their respective largest lateral surfaces, which are in particular each arranged perpendicular to the upper lateral surface and to the lower lateral surface. It should at this point be noted that the longitudinal direction of the battery module is in this case accordingly arranged perpendicular to the largest lateral surfaces of the battery cells.

It is expedient if a second first busbar is electrically conductively connected to the first connection of the electrical switching device. In particular, such a connection is formed as a material bond, for example by means of a welded connection. Furthermore, the second first busbar is electrically conductively connected to the first first busbar. In particular, such a connection is formed as a material bond, for example by means of a welded connection.

In particular, the second first busbar is arranged below the first busbar.

The first heat pipe is arranged between the first first busbar and the second first busbar.

It is also expedient if a second second busbar is electrically conductively connected to the second connection of the electrical switching device. In particular, such a connection is formed as a material bond, for example by means of a welded connection. Furthermore, the second second busbar is electrically conductively connected to the first second busbar. In particular, such a connection is formed as a material bond, for example by means of a welded connection.

The second heat pipe is arranged between the first second busbar and the second second busbar.

It is also expedient if the first first busbar is still connected to the first connection and a first heat-conducting element is connected to the first first busbar. In particular, such connections are each formed by a material bond, for example by means of a welded connection.

The first heat pipe is arranged between the first first busbar and the first heat-conducting element.

Furthermore, it is also expedient if the first second busbar is still connected to the second connection and a second heat-conducting element is connected to the first second busbar.

In particular, such connections are each formed by a material bond, for example by means of a welded connection.

The second heat pipe is arranged between the first second busbar and the second heat-conducting element.

A first heat-conducting element and a second heat-conducting element offer the advantage that a thermal connection surface to the first heat pipe and the second heat pipe can be increased or maximized.

Preferably, the first heat pipe is arranged in an electrically insulating manner from the first first busbar, the second first busbar and/or the first heat-conducting element and/or the second heat pipe is arranged in an electrically insulating manner from the first second busbar, the second second busbar and/or the second heat-conducting element. As a result, an electrical path and a thermal path can be reliably separated from each other.

It is advantageous if the electrical insulation is provided by means of a spacer element designed to be electrically insulating. The first heat pipe and/or the second heat pipe are each accommodated in a spacer element. The spacer element is preferably designed as a plastic injection-molded component.

Furthermore, the electrical insulation can be formed by means of a balancing element designed to be electrically insulating.

Preferably, the spacer element and/or the balancing element can comprise thermally conductive additives so that heat transfer can be reliably increased.

It is advantageous if the plurality of battery cells is accommodated in a housing of the battery module, wherein the housing is made of a plastic. In particular, the housing is designed as a plastic injection-molded component. This offers the advantage that electrical insulation is formed between the plurality of battery cells and the housing of the battery module.

Furthermore, a plastic design offers the advantage that a comparable degree of freedom in the design of the housing can be provided and weight can be reduced compared to housings made of metal.

Preferably, the electrical switching device can be connected to the housing of the battery module, e.g. a base of the housing of the battery module, by means of mechanisms such as screw connections.

It is advantageous if the thermally conductive connection between the first heat pipe and the temperature control body and/or between the second heat pipe and the temperature control body is formed within the housing of the battery module. This offers the advantage that a seal between the first heat pipe and the housing of the battery module and between the second heat pipe and the housing of the battery module is unnecessary and only a seal between the temperature control element and the housing of the battery module needs to be formed. For example, such a seal could be formed by means of a sealing ring accommodated in a sealing groove.

In particular, it is possible to specifically adapt the design of the temperature control element to the respective requirements, especially since the temperature control body is not an integral part of the housing.

It is advantageous if the temperature control body is arranged on the outside of the housing, wherein the temperature control body is designed in particular as an extruded heat sink. Arranging the temperature control body on an external side can facilitate reliable heat exchange with the surroundings of the battery module, in particular the ambient air. Furthermore, the temperature control body can be arranged almost anywhere on the outside of the housing.

Preferably, the temperature control body can be connected to the housing of the battery module, e.g. the outside of the housing of the battery module, by means of mechanisms such as screw connections.

Conveniently, the thermal contact surface of the first first busbar, the second first busbar, the second heat-conducting element, the first second busbar, the second second busbar and/or the second heat-conducting element have a semicircular cross-sectional area. This allows a maximized thermal contact surface to be formed with the first heat pipe and the second heat pipe.

### BRIEF DESCRIPTION OF THE DRAWINGS

Embodiment examples of the invention are shown in the drawings and explained in more detail in the following description.

### Shown are:

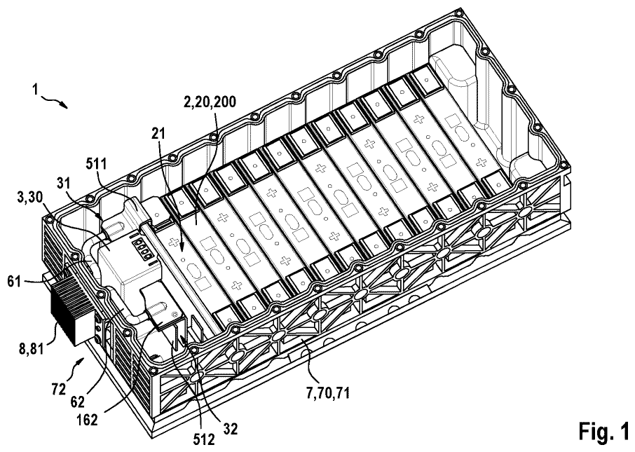

FIG. 1 a perspective view of an embodiment of a battery module according to the invention,

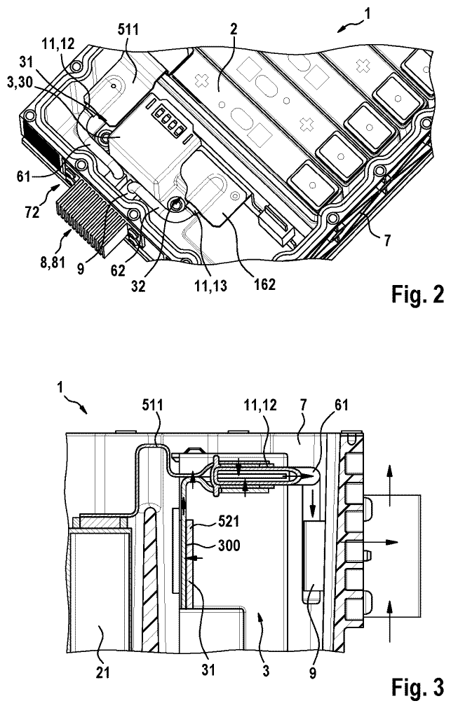

FIG. 2 a plan view of the embodiment of the battery module according to the invention as shown in FIG. 1,

FIG. 3 a sectional view from the side of the embodiment of the battery module according to the invention as shown in FIG. 1,

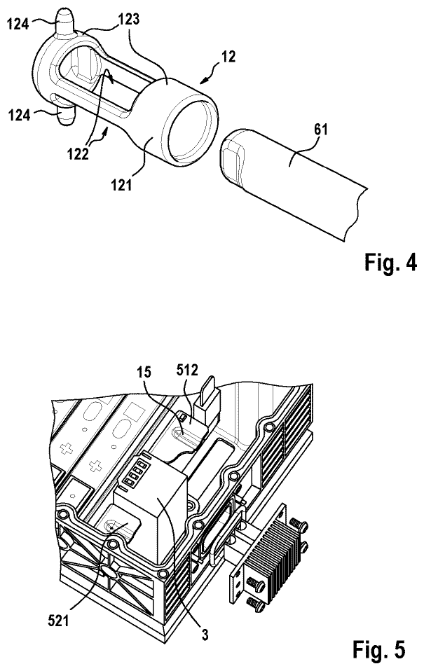

FIG. 4 a spacer element of the embodiment of the battery module according to the invention as shown in FIG. 1,

FIG. 5 a step in the manufacture of a battery module according to the invention,

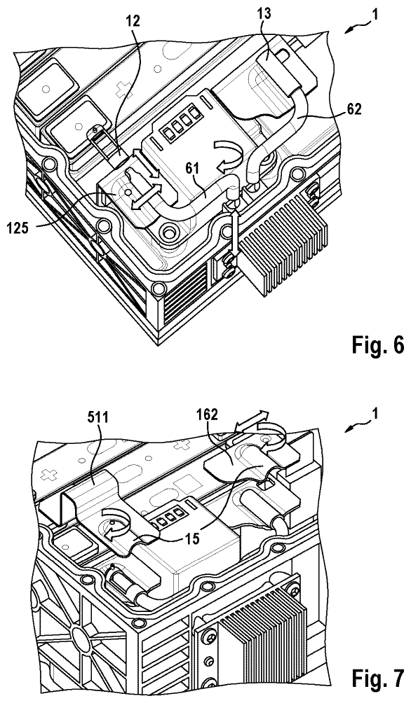

FIG. 6 a further step in the manufacture of a battery module according to the invention,

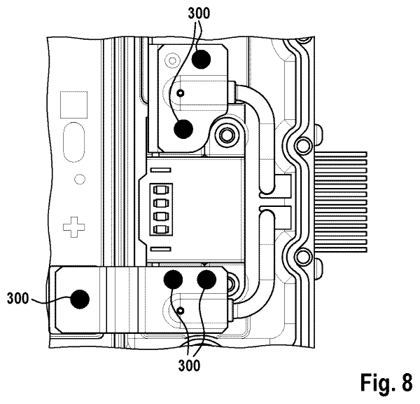

FIG. 7 yet another step of manufacturing a battery module according to the invention and

FIG. 8 another plan view of the embodiment of the battery module according to the invention as shown in FIG. 1.

### DETAILED DESCRIPTION

FIG. 1 shows a perspective view of an embodiment of a battery module 1 according to the invention.

The battery module 1 comprises a plurality of battery cells 2, which are designed in particular as lithium-ion battery cells 20. Furthermore, the battery cells 2 are designed in particular as prismatic battery cells 200.

Furthermore, the battery module 1 comprises an electrical switching device 3, in particular a relay 30.

The plurality of battery cells 2 and, in particular, the electrical switching device 3 are accommodated in a housing 7 of the battery module 1. The housing 7 is made of a plastic material 70. In particular, the housing 7 is designed as a plastic injection-molded component 71.

A first connection 31 of the electrical switching device 3 is electrically conductively connected to a battery cell 21 of the plurality of battery cells 2 by means of a first first busbar 511.

The first busbar 511 is electrically conductively connected to the battery cell 21.

A second connection 32 of the electrical switching device 3 is electrically conductively connected by means of a first second busbar 512 to an overall voltage tap 4 of the battery module 1, which cannot be seen in FIG. 1.

Furthermore, a first heat pipe 61 is thermally conductively connected to the first first busbar 511. Furthermore, a second heat pipe 62 is thermally conductively connected to the first second busbar 512.

The first heat pipe 61 and the second heat pipe 62 are thermally conductively connected to a temperature control body 8. Furthermore, the temperature control body 8 is arranged on an outer side 72 of the housing 7. In particular, the temperature control body 8 is designed as an extruded heat sink 81.

The first second busbar 512 is further connected to the second connection 32. Furthermore, a second heat conduction element 162 is connected to the first second busbar 512. In this case, the second heat pipe 62 is arranged between the first second busbar 512 and the second heat-conducting element 162.

Alternatively, which cannot be seen in the figures, the battery module 1 can also comprise a second second busbar 522, which is electrically conductively connected to the second connection 32 of the switching device 3, in particular with a material bond, for example by means of a welded connection 300. The second second busbar 522 can furthermore be electrically conductively connected to the first second busbar 512. In this case, the second heat pipe 62 would be arranged between the first second busbar 512 and the second second busbar 522.

FIG. 2 shows the embodiment of the battery module 1 according to the invention as shown in FIG. 1 in a plan view, and FIG. 3 shows embodiments of the battery module 1 according to the invention as shown in FIG. 1 in a sectional view from the side.

FIGS. 2 and 3 will be described together below.

First of all, the plurality of battery cells 2 and the battery cell 21 can be seen.

Furthermore, the first connection 31 and the second connection 32 can be recognized or are indicated.

The battery module 1 further comprises a second first busbar 521, which is electrically conductively connected to the first connection 31 of the switching device 3, in particular with a material bond, for example by means of a welded connection 300. The second first busbar 521 is also electrically conductively connected to the first busbar 511.

It can be seen in particular from FIG. 3 that the first heat pipe 61 is arranged between the first first busbar 511 and the second first busbar 521.

Alternatively, which cannot be seen in the figures, the first first busbar 511 can also continue to be connected to the first connection 31. Furthermore, a first heat conduction element 161 would be connected to the first first busbar 511. In this case, the first heat pipe 61 is arranged between the first first busbar 511 and the first heat-conducting element 161.

The first heat pipe 61 is arranged in an electrically insulating manner from the first first busbar 511 and the second first busbar 521.

The electrical insulation 11 is formed by means of a spacer element 12, which is designed to be electrically insulating. The first heat pipe 61 is accommodated within the spacer element 12.

The second heat pipe 62 is arranged in an electrically insulating manner from the first second busbar 512 and the second heat-conducting element 162.

In this case, such electrical insulation 11 is formed by means of a balancing element 13 designed to be electrically insulating.

FIG. 2 also shows that the thermally conductive connections 9 between the first heat pipe 61 and the temperature control body 8 and between the second heat pipe 62 and the temperature control body 8 are formed inside the housing 7 of the battery module 1.

FIG. 4 shows a spacer element 12 of the embodiment of the battery module according to the invention as shown in FIG. 1.

The spacer element 12 has a substantially cylindrical hollow body 121 which comprises two recesses 122 arranged opposite each other. Accordingly, in other words, the spacer element 12 has, for example, a semicircular recess on an upper side and on an underside. This allows reliable thermal contacting to be formed.

The first heat pipe 61, for example, can be accommodated within the cylindrically shaped hollow body 121. By means of two rings 123, a spacing designed to be electrically insulating can be formed, for example, between the first first heat pipe 61 and the first busbar 511 as well as the second first busbar 521.

Furthermore, a thermal compensation material, which is designed to be electrically insulating, can be arranged in the area of the recesses 122, which enables reliable thermal contact. In particular, the thermal compensation material can be a so-called gap filler or a thermally conductive adhesive.

Furthermore, the spacer element 12 comprises alignment elements 124.

FIG. 5 shows a step in the manufacture of a battery module 1 according to the invention.

It can be seen, for example, that the second first busbar 521 and the first second busbar 512 each have semicircular cross-sectional areas 15.

FIG. 6 shows a further step in the manufacture of a battery module 1 according to the invention.

It can be seen here that the first heat pipe 61 and the second heat pipe 62 are accommodated in receiving regions of the second first busbar 521 and the first second busbar 512, which each have the semicircular cross-sectional areas 15.

In particular, the first heat pipe 61 is accommodated within a spacer element 12. Furthermore, an alignment element 124 of the spacer element 12 can engage in a recess 125 of the second first busbar 511 in order to enable reliable positioning.

In particular, the second heat pipe 62 further comprises a balancing element 13 designed to be electrically insulating,.

FIG. 7 shows a further step in the manufacture of a battery module 1 according to the invention.

It can be seen that the first busbar 511 and the second heat conduction element 162 are arranged.

It can be seen, for example, that the first first busbar 511 and the second heat-conducting element 162 each have semicircular cross-sectional areas 15.

Furthermore, an alignment element 124 of the spacer element 12 can engage in a recess 125 of the first first busbar 511 in order to enable reliable positioning.

FIG. 8 shows the embodiment of the battery module 1 according to the invention as shown in FIG. 1 in a further plan view.

In particular, welded connection 300 can be seen here.

1. A battery module having a plurality of battery cells (2), and
having an electrical switching device (3), wherein
a first connection (31) of the electrical switching device (3) is provided by a first first busbar (511), which is electrically conductively connected to a battery cell (21) of the plurality of battery cells (2), and
a second connection (32) of the electrical switching device (3) is electrically conductively connected to an overall voltage tap (4) of the battery module (1) by a first second busbar (512),
wherein
a first heat pipe (61) is thermally conductively connected to the first first busbar (511) and/or
a second heat pipe (62) is thermally conductively connected to the first second busbar (512), and wherein,
the first heat pipe (61) and/or the second heat pipe (62) are thermally conductively connected to a temperature control body (8).

2. The battery module according to claim 1, wherein a second first busbar (521), which is electrically conductively connected to the first connection (31) of the switching device (3), is further electrically conductively connected to the first first busbar (511),
wherein the first heat pipe (61) is arranged between the first first busbar (511) and the second first busbar (521), and/or
a second second busbar (522), which is electrically conductively connected to the second connection (32) of the switching device (3), is furthermore electrically conductively connected to the first second busbar (512),
wherein the second heat pipe (62) is arranged between the first second busbar (512) and the second second busbar (522).

3. The battery module according to claim 1, wherein the first first busbar (511) is electrically conductively connected to the first connection (31) and a first heat-conducting element (161) is connected to the first first busbar (511), wherein
the first heat pipe (61) is arranged between the first first busbar (511) and the first heat-conducting element (161), and/or
the first second busbar (512) is furthermore electrically conductively connected to the second connection (32) and a second heat-conducting element (162) is connected to the first second busbar (512), wherein
the second heat pipe (62) is arranged between the first second busbar (512) and the second heat-conducting element (162).

4. The battery module according to claim 1, wherein the first heat pipe (61) is arranged in an electrically insulating manner from the first first busbar (511), the second first busbar (521) and/or the first heat-conducting element (161),
and/or the second heat pipe (62) is arranged in an electrically insulating manner from the first second busbar (512), the second second busbar (522) and/or the second heat-conducting element (162).

5. The battery module according to claim 4, wherein an electrical insulation (11) is formed by a spacer element (12), which is configured to be electrically insulating, wherein the first heat pipe (61) and/or the second heat pipe (62) are each accommodated in a spacer element (12).

6. The battery module according to claim 5, wherein the electrical insulation (11) is formed by a balancing element (13), which is configured to be electrically insulating.

7. The battery module according to claim 1, wherein the plurality of battery cells (2) are accommodated in a housing (7) of the battery module (1), wherein the housing (7) is formed from a plastic (70).

8. The battery module according to claim 7, wherein a thermally conductive connection (9) is formed between the first heat pipe (61) and the temperature control body (8), and/or between the second heat pipe (62) and the temperature control body (8), inside the housing (7) of the battery module (1).

9. The battery module according to claim 7, wherein the temperature control body (8) is arranged on an outer side (72) of the housing (7).

10. The battery module according to claim 2, wherein a thermal contact surface of the first first busbar (511), the second first busbar (521), a first heat-conducting element (161), the first second busbar (512), the second second busbar (522) and/or a second heat-conducting element (162) have a semicircular cross-sectional area (15).

11. The battery module according to claim 1, wherein the plurality of battery cells (2) are lithium-ion battery cells (20).

12. The battery module according to claim 1, wherein the electrical switching device (3) is a relay (30).

13. The battery module according to claim 7, wherein the housing (7) is as a plastic injection-molded component (71).

14. The battery module according to claim 9, wherein the temperature control body (8) is configured as an extruded heat sink (81).
